(19) United States
(12) Patent Application Publication
(10) Pub. No.: US 2002/0161623 A1
(43) Pub. Date: Oct. 31, 2002

(54) Method of providing comparative market information

(76) Inventors: Patrick D. Butler, Shawnee, KS (US); Andrew M. Pole, Shawnee, KS (US); Gene R. Givan, Lee's Summit, MO (US)

Correspondence Address: Pillsbury Winthrop LLP, Intellectual Property Group, 50 Fremont Street, San Francisco, CA, 94105, US

(21) Appl. No.: 09/844,287

(22) Filed: Apr. 27, 2001

(51) Int. Cl. G06F 17/60

(52) U.S. Cl. 705/10

(57) ABSTRACT

A method of providing information with respect to a market displays, for each of a plurality of market participants, information with respect to the total number and value of units sold during a period in each of a plurality of channels of the market. The method displays graphical controls by which a user may select a style of displaying the information with respect to number and value of units sold. The method may also display graphical controls for enabling the user to display additional information with respect to each of the market participants in each of the channels.

### FIELD OF THE INVENTION

The present invention relates to the field of market research tools, and more particularly to a computer-implemented method of providing market information with respect to each of a plurality of market participants in each of a plurality of channels.

### DESCRIPTION OF THE PRIOR ART

In today's highly competitive markets, manufacturers and retailers need as much information as possible in order to determine the respective market positions and to plan for the future. It is vital that market participants know their respective market shares in various marketing channels and with respect to various brands or product lines. Knowledge of channels and brands in which a market participant is gaining or losing market share is important for the market participant to stay, or become more, competitive.

Because market information is so vital, market participants tend to collect vast amounts of data. However, people can process and understand only limited amounts of data. Accordingly, there is a need for a method of displaying data in a readily understandable and digestible form.

### SUMMARY OF THE INVENTION

The present invention provides a method of providing information with respect to a market. The method of the present invention displays, for each of a plurality of market participants, information with respect to the total number and value of units sold during a period in each of a plurality of channels of the market. The market may be a national market or a user selected metropolitan area. Preferably, the information is displayed in a table in which the market participants are associated with a first axis and the channels are associated with a second axis.

The method displays graphical controls by which a user may select a style of displaying the information with respect to number and value of units sold. One of the styles the user may select is actual total number and dollar value of units sold. Selection of this control gives the user a view of the absolute size of the business done by each market participant in each channel, and in the market as a whole. Another style the user may select is percentage of the number and value of units sold by a particular market participant in a particular channel compared to the total number of units sold and value in the entire market. Selection of this control gives the user a view each participant's relative share in each channel. A further style a user may select is percentage of the number and value of units sold compared to the total number and value of units sold across all channels. Selection of this control gives the user insight into how a particular market participant uses the various market channels. Yet a further style a user may select is percentage of the number and value of units sold compared to the total number of units and value sold in a channel by all market participants. Selection of this style gives the user a view of the each participant's share of the market in each channel.

The method of the present invention may also display graphical controls for enabling the user to display additional information with respect to each of the market participants in each of the channels. For example, the user may display unit or value market share change from one period to another. Additionally, the user may display pricing information, such as average unit price, discount percentage, or average percentage unit price change from one period to another, for each participant in each channel. The user may also display unit or value volume percentage change from one period to another for each participant in each channel.

### BRIEF DESCRIPTION OF THE DRAWINGS

FIG. 1 is a block diagram of a system according to the present invention.

FIG. 2 is a pictorial view of a computer display screen showing number and value of units sold in terms of actual values for the entire market.

FIG. 3 is a pictorial view of a computer display screen showing number and value of units sold in terms of percentage of the entire market.

FIG. 4 is a pictorial view of a computer display screen showing number and value of units sold in terms of percentages for each market participant across all market channels.

FIG. 5 is a pictorial view of a computer display screen showing number and value of units sold in terms of market share percentage for each market participant in each market channel.

FIG. 6 is a pictorial view of a computer display screen showing number and value of units sold in terms of percentage of the entire market and the average price paid and discount percentage for each market participant in each market channel.

FIG. 7 is a pictorial view of a computer display screen showing number and value of units sold in terms of percentage of the market in a selected metropolitan area and the average price paid and discount percentage for each market participant in each market channel.

FIG. 8 is a pictorial view of a computer display screen similar to the display of FIG. 7, with the information for one market participant expand to the brand level and the information for one market channel expanded to the sub-channel level.

### DESCRIPTION OF THE PREFERRED EMBODIMENT

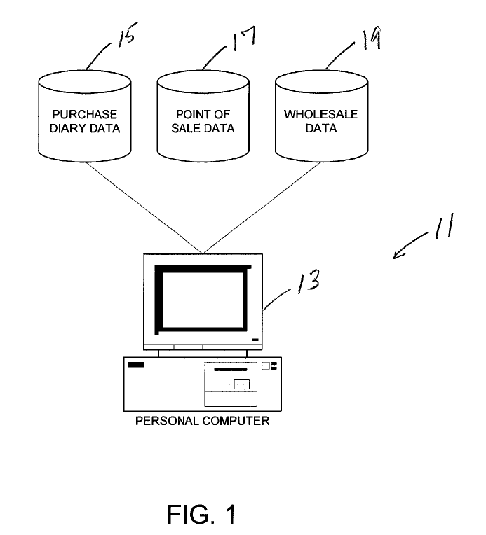

Referring now to the drawings, and first to FIG. 1, a system adapted to implement the method of the present invention is designated generally by the numeral 11. System 11 includes a personal computer 13 that is programmed according to the present invention. Personal computer 13 has access to various data, including purchase diary data 15, point-of-sale data 17 and wholesale data 19. Purchase diary data 15 is in the nature of survey data typically obtained from a market research organization. The market research organization provides a selected number of households with a purchase diary. Participants in the purchase diary program enter purchase information into their diaries. The market research organization collects the diaries and then uses statistical sampling techniques to extrapolate the results to a market, which may be the entire nation or a certain metropolitan area. Purchase diary data 15 provides information with respect to all participants in the market.

Point-of-Sale data 17 and wholesale data 19 are data collected from retailers and within the organization itself. Point-of-Sale data 17 and wholesale data 19 may be used as a check on the accuracy of the purchase diary data and to aid in extrapolating the purchase diary data.

The system shown in FIG. 1 is a stand-alone system. However, as will be recognized by those skilled in the art, the method of the present invention may be implemented in a distributed or network environment.

The present invention provides a graphical user interface into a data handling application, such as a spreadsheet. An example of the spreadsheet with which the graphical user interface of the present invention may be used is Microsoft#Excel#. Preferably, the underlying spreadsheet provides pivot table functions.

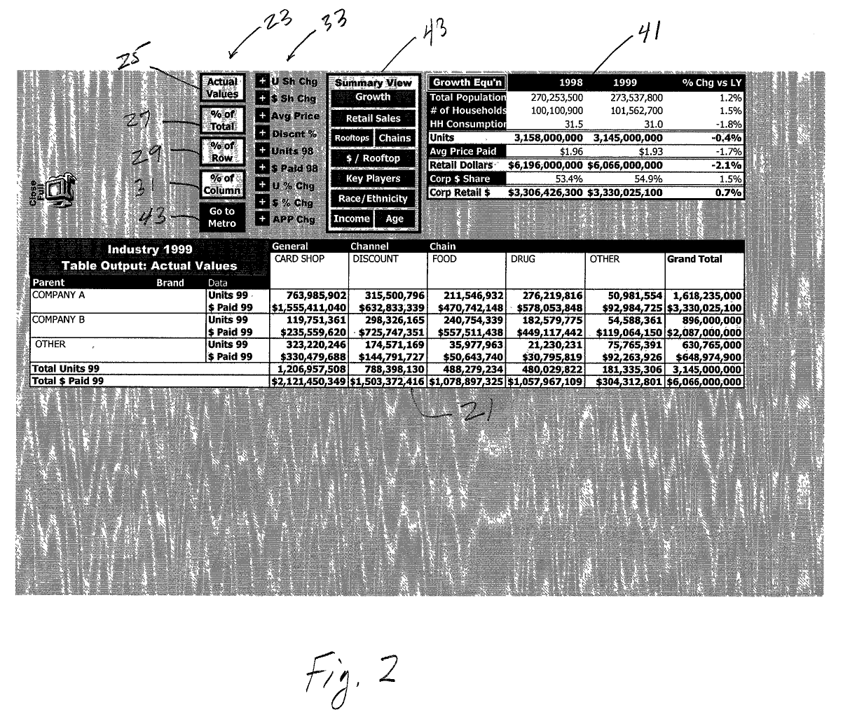

Screens providing examples of features of the method of the present invention are illustrated in FIGS. 2-8. Referring first to FIG. 2, a screen according to the present invention includes an interactive table 21 that allows a user to view information with respect to various market participants in various channels. In the screen of FIG. 2, the information is given with respect to the entire market, which in the illustrated embodiment is the greeting card business for the entire United States in calendar year 1999. The market participants are associated with rows of Table 21 and they are identified as Company A, Company B and other. The other category includes substantially all market participants besides Company A and Company B. Each column of Table 21 is associated with a market channel. In the example of FIG. 2, the channels are card shops, discount stores, food stores, drug stores, and others. The other category includes such establishments as department stores and other miscellaneous retailers.

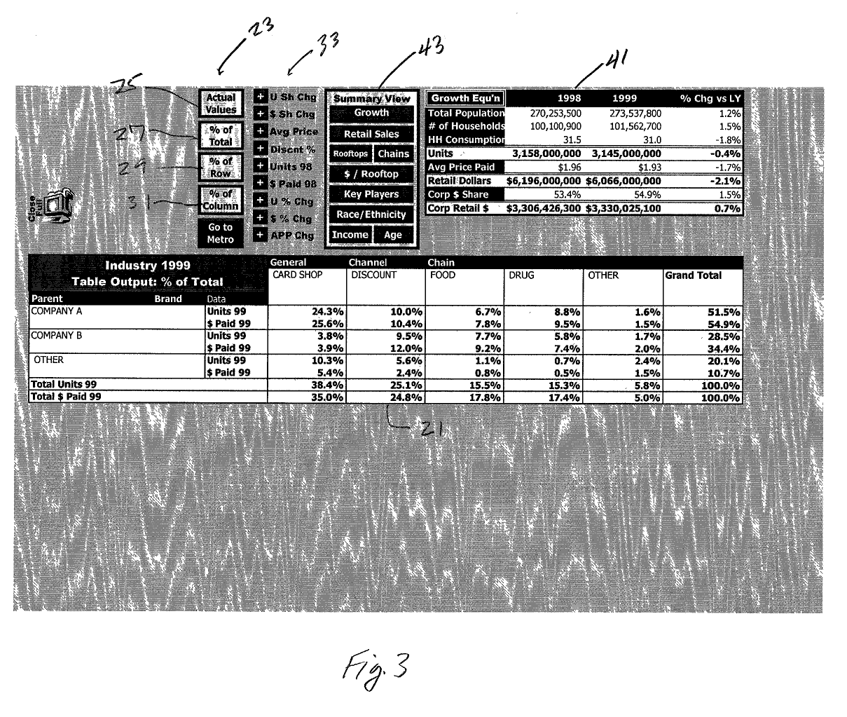

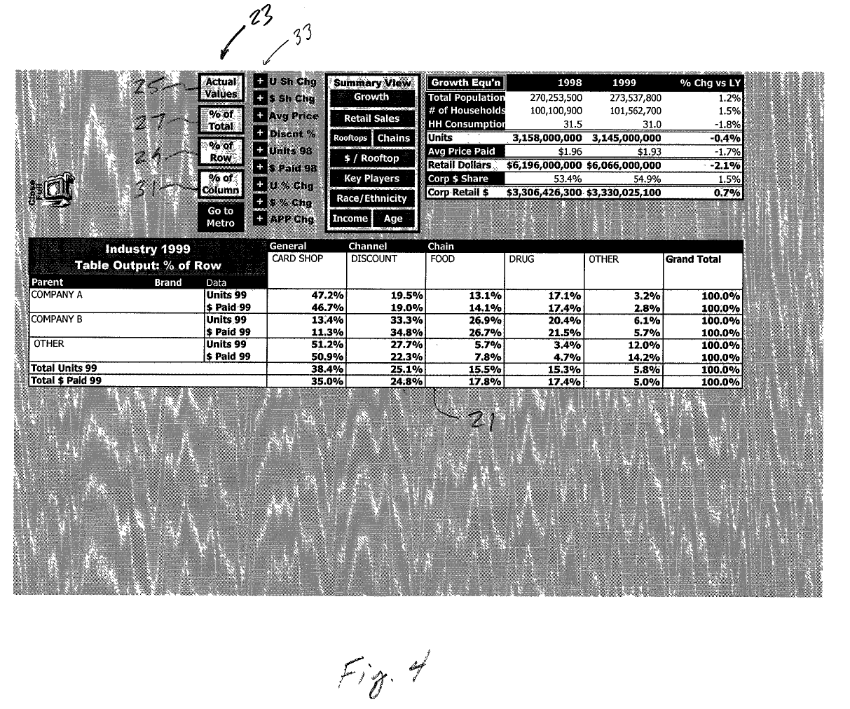

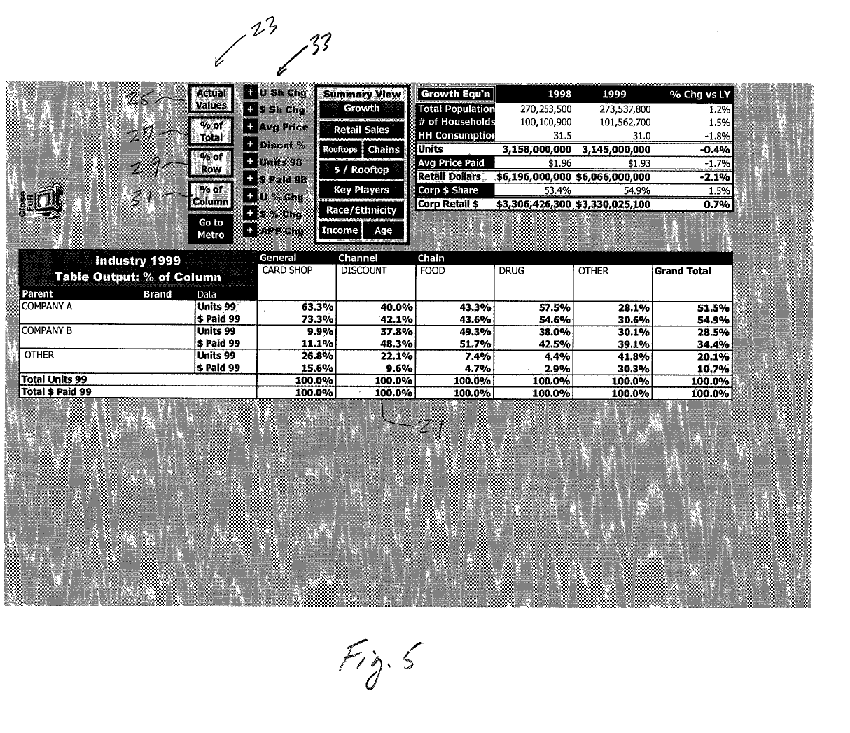

The basic information provided with respect to each market participant in each channel in Table 21 is units sold and dollars paid during the period. According to the present invention, the basic information can be displayed in any of four user selectable styles. A column of buttons 23 is provided with which the user may select the presentation style. In FIG. 2, the presentation style is actual values, which is selected by clicking on actual values button 25. The other presentation styles include: percent of total, which is selected with button 27 and illustrated in FIG. 3; percent of row, which is selected with button 29 and illustrated in FIG. 4; and percent of column, which is selected with button 31 and illustrated in FIG. 5.

The various presentation styles presented according to the present invention provide the user with different views of the data and provide the user with different information with respect to the market. In the actual values presentation style of FIG. 2, the information is presented in absolute terms. In the percent of total presentation style of FIG. 3, the user can tell quickly what share a particular market participant has of the total market in a particular channel. For example, referring to FIG. 3, a user can tell that Company A sold 24.3% of all greeting cards sold in the United States in 1999 in card shops.

The percent of row presentation style, as illustrated in FIG. 4, illustrates how a particular market participant's sales are distributed across the marketing channel. For example, referring to FIG. 4, Company A sold 47.2% of its units through the card shop channel while Company B sold only 13.4% of its units through that channel. The percent of rows presentation style gives the user information as to the channels in which the market participants devote their efforts.

The percent of column presentation style, which is illustrated in FIG. 5, displays each market participant's market share in each channel. Referring to FIG. 5, in terms of units sold, Company A has a 63.3% share of the card shop channel as compared to Company B's 9.9% share in that channel.

The graphical user interface of the present invention also includes a column of buttons 33 with which the user may select to display data in addition to the basic units sold and dollars paid data. The additional data includes unit share change (year-to-year), dollar share change (year-to-year), average price paid, discount percentage, units sold in the prior years, dollars paid in the prior year, unit percentage change (year-to-year), dollar percentage change (year-to-year) and average price paid change (year-to-year). The user can select to display any of the additional data by clicking on the plus sign icon associated with the additional data label.

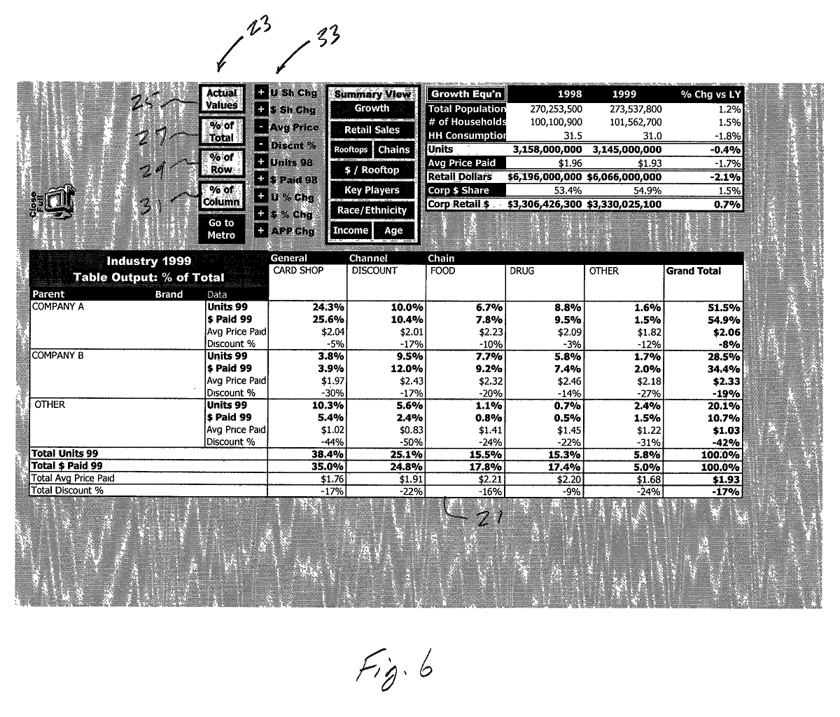

Referring to FIG. 6, there is shown an example of Table 21 in which the average price and discount percentage buttons have been selected. As shown in FIG. 6, the average price paid for cards of Company A in the card shop channel is $2.04 while the average price paid for the cards of Company B in the card shop channel is $1.97. The user can revert to the display of FIG. 3 by clicking on the minus sign icons next to the average price and discount percentage labels of FIG. 6.

The user interface of the present invention also provides user selectable summary tables that provide various demographic information with respect to the market. The demographic information is presented in a summary Table 41. The content of Summary Table 41 is selected with a set of controls in a summary view field 43. The summary demographic information includes a growth equation, which is currently displayed in summary Table 41, retail sales, roof tops, chains, dollars per roof top, key players, race/ethnicity, income, age. The summary demographic information is particularly useful with respect to an analysis of market shares in particular metropolitan areas.

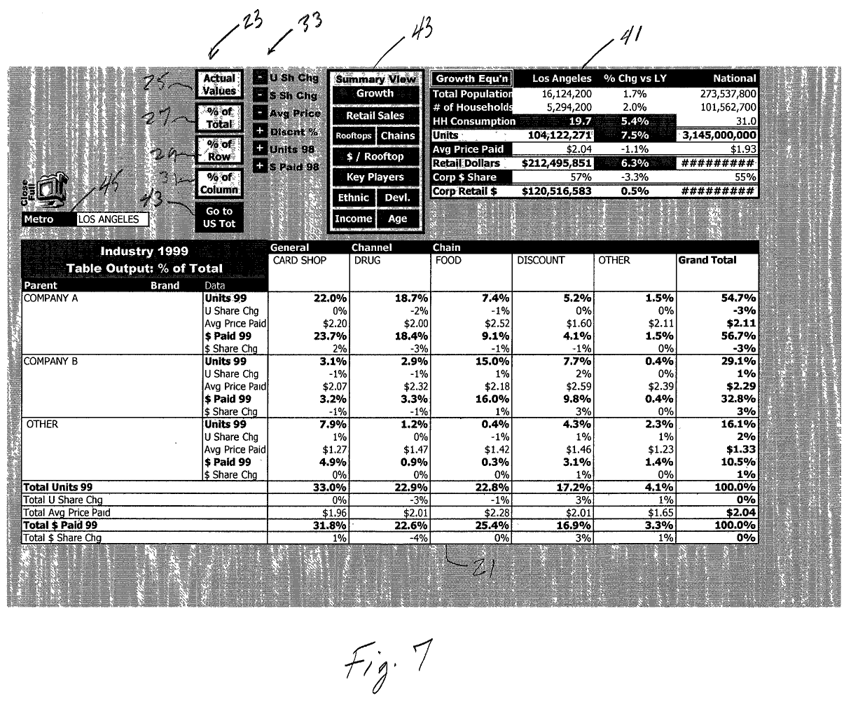

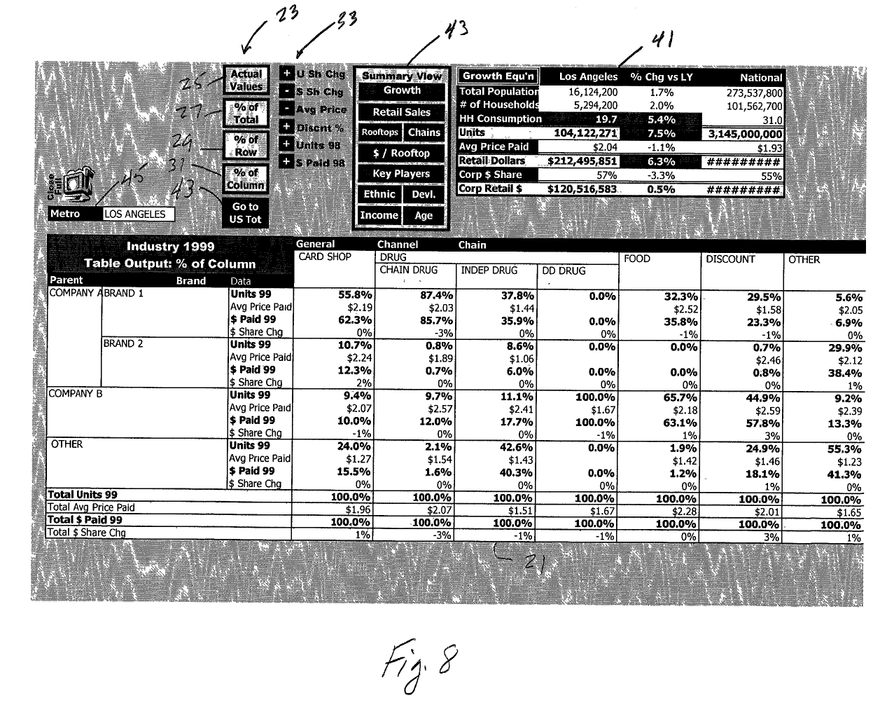

The data displayed in tables 21 and 41 may be for the market as a whole as shown in FIGS. 2-6 or for a selected metropolitan area, as shown in FIGS. 7 and 8. A control 43 is provided to enable the user to toggle back and forth between the entire market view and the metropolitan area view. In FIGS. 2-6 control 43 is labeled Go To Metro. The user may go to the metropolitan area view by clicking on control 43.

An example of a metropolitan area view is displayed in FIGS. 7 and 8. Referring to FIGS. 7 and 8, the user interface of the present invention includes a drop down menu 45 with which the user can select to view any of about 40 metropolitan areas in the United States. In FIG. 7, the user has selected the Los Angeles metropolitan area. The information shown in tables 21 and 41 of FIG. 7 is of the same type as that displayed in tables 21 and 41 of FIG. 2-6. However, the information relates only to the Los Angeles metropolitan area.

Another feature of the user interface of the present invention is illustrated with respect to FIG. 8. The user interface of the present invention provides for increased granularity with respect to both brands and sub-channels. As shown in FIG. 8, the information with respect to FIG. A is divided among its brands, which are designated as Brand 1 and Brand 2. Similarly, the drug channel information is divided among three drug sub-channels including chain drug stores, independent drug stores and discount drug stores. The more granular information is displayed by double clicking on the parent label. For example, the Brand 1 and Brand 2 information is displayed by double clicking on the Company A label. Similarly, the chain drug, independent drug, and discount drug information is displayed by double clicking on the drug label. The information can be collapsed back by double clicking on the parent label.

From the foregoing, it may be seen that the method of the present invention provides a user interface by which a user can display complex market information share information in a flexible, easily understandable and digestible way. The user interface of the present invention provides multiple views into the data in multiple levels of granularity. The user can view more or less information, according to the user's needs.

What is claimed is:

1. A method of providing information with respect to a market, which comprises the computer implemented steps of:
displaying, for each of a plurality of market participants, information with respect to number of units sold and value of units sold in each of a plurality of channels for a period; and,
displaying a graphical control for enabling a user to select a style of displaying said information with respect to number of units sold and value of units sold.

2. The method as claimed in claim 1, wherein said style is actual number of units sold and actual value.

3. The method as claimed in claim 1, wherein said style is percentage of the number of units sold and value compared to the total number of units sold and value in the entire market.

4. The method as claimed in claim 1, wherein said style is percentage of the number of units sold and value compared to the total number of units sold and value by a market participant across all channels.

5. The method as claimed in claim 1, wherein said style is percentage of the number of units sold and value compared to the total number of units sold and value in a channel by all market participants.

6. The method as claimed in claim 1, wherein said period is a calendar year.

7. The method as claimed in claim 1, including the computer implemented step of:
displaying a graphical control for enabling said user to display additional information for each of said market participants in each of said channels.

8. The method as claimed in claim 7, wherein said additional information includes:
unit market share change from prior period to said period

9. The method as claimed in claim 7, wherein said additional information includes:
value market share change from a prior period to said period.

10. The method as claimed in claim 7, wherein said additional information includes:
average unit price.

11. The method as claimed in claim 7, wherein said additional information includes:
number of units sold in a prior period.

12. The method as claimed in claim 7, wherein said additional information includes:
value of units sold in a prior period.

13. The method as claimed in claim 7, wherein said additional information includes:
percentage change of number of units sold in said period compared to a prior period.

14. The method as claimed in claim 7, wherein said additional information includes:
percentage change of value of units sold in said period compared to a prior period.

15. The method as claimed in claim 1, wherein said information with respect to number of units sold and value of units sold is displayed in a table wherein said market participants are associated with a first axis of said table and said channels are associated with a second axis of said table.

16. The method as claimed in claim 1, wherein said market is a user selectable metropolitan area.

17. The method as claimed in claim 1, wherein said market is a national market.

18. The method as claimed in claim 1, including the computer implemented step of:
displaying user selectable demographic information.

19. The method as claimed in claim 1, wherein said information is derived from point of sale data.

20. The method as claimed in claim 1, wherein said information is derived from wholesale sales data.

21. The method as claimed in claim 1, wherein said information is derived from market survey data data.

22. The method as claimed in claim 1, including the computer implemented step of:
displaying, in response to user interaction, market information with respect to separate brands of a market participant.

23. The method as claimed in claim 1, including the computer implemented step of:
displaying, in response to user interaction, market information with sub-channels within a channel.
